(19) United States
(12) Patent Application Publication
(10) Pub. No.: US 2011/0300110 A1
(43) Pub. Date: Dec. 8, 2011

(54) ENAMINOCARBONYL COMPOUND/BENEFICIAL ORGANISM COMBINATIONS

(75) Inventors: Heike Hungenberg, Langenfeld (DE); Robert Velten, Langenfeld (DE); Peter Jeschke, Bergisch Gladbach (DE); Hans-Jürgen Schnorbach, Monheim (DE); Wolfram Andersch, Bergisch Gladbach (DE)

(73) Assignee: BAYER CROPSCIENCE AG, Monheim (DE)

(21) Appl. No.: 13/132,569

(22) PCT Filed: Dec. 3, 2009
(86) PCT No.: PCT/EP2009/008615

§ 371 Date: Aug. 29, 2011

(30) Foreign Application Priority Data
Dec. 5, 2008 (EP) 08170790.3

(51) Int. Cl. A01N 63/00; A01P 17/00; A01P 7/02; A01P 7/04; A01N 43/40; A01N 43/78

(52) U.S. Cl. 424/93.4; 424/93.6; 514/336; 514/365

(57) ABSTRACT

The novel combinations of enaminocarbonyl compounds and beneficial species comprising, firstly, at least one enaminocarbonyl compound of the formula (I)

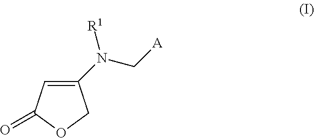

in which
R¹ and A have the meanings given in the description, and, secondly, at least one beneficial species (natural enemy).

The present invention relates to novel active compound/beneficial species combinations consisting, firstly, of known enaminocarbonyl compounds and, secondly, of beneficial species (natural predators), which combinations are highly suitable for controlling animal pests such as insects and/or unwanted acarids. The invention also relates to the use of certain enaminocarbonyl compounds in combination with certain beneficial species for controlling animal pests.

The preparation of certain enaminocarbonyl compounds and their use as agents for controlling animal pests, in particular insects and acarids, is known (for example EP 0 539 588 A, WO 2006/037475 A, WO 2007/115643, WO 2007/115644 and WO 2007/115646). That the insecticidal and acaricidal activity of individual enaminocarbonyl compounds can be enhanced by addition of suitable salts and optionally additives is also known (WO 2007/068355).

The efficacy of the enaminocarbonyl compounds is good; however, at low application rates it is sometimes unsatisfactory.

The use of beneficial species for controlling pests is generally known (for example from “Knowing and recognizing”; M. H. Malais, W. J. Ravensberg, published by Koppert B. V., Reed Business Information (2003)). Beneficial species are in most cases arachnids or insects which are in some way or other useful for man, in particular by relying on other insects, for their part referred to as pests, as food or as a host. However, the term “beneficial species” is not limited to arachnids and insects. In the present invention, it also includes fungi or bacteria or virus strains suitable for controlling pests. Beneficial species are particularly suitable for controlling pests in greenhouses. The use of beneficial species has the advantage that no resistances are developed and that there are no waiting times for cultivation and care measures and for harvesting. Moreover, by employing beneficial species, the user is not exposed to crop protection agents.

For pest control, a sufficient quantity of beneficial species is released or inoculated at the site of action (for example in a greenhouse). In general, the beneficial species are only employed in case of an attack by pests (curative). Since beneficial species are the natural enemies of the pests to be controlled, their activity spectrum is frequently limited to the specific pest and in some cases even to specific development stages of these pests. However, since a plurality of pest species having different control requirements, such as, for example, time of application, beneficial species and beneficial species climate, may occur in a crop, the crop has to be monitored regularly and requires a rapid reaction in the case of an attack. Moreover, the user has to have in-depth knowledge of the crop, the pests and the beneficial species.

If the attack by pests is noticed too late and as a result the pest population has grown too much, beneficial species alone are not sufficient to control the pests, and a combined use of the beneficial species with chemical pesticides is required. Here, it is the aim to decimate the pest population to such an extent that the beneficial species present are capable of controlling the remaining population.

For economical and environmental reasons and to avoid resistance, it may also be advantageous to use chemical crop protection compositions in concentrations in which the activity of the crop protection composition is sufficient to reduce the pest population, but the concentrations are not high enough to eliminate the pests completely. In such a case, the presence of beneficial species may lead to the pest infestation to be controlled or reduced or eliminated in due course by the beneficial species.

The disadvantage of the combined use of crop protection compositions and beneficial species is in particular that some crop protection compositions such as, for example, Karate Zeon CS 100®, which comprises the active compound lambda-cyhalothrin in a capsule suspension (100 g/l), kills both pests and beneficial species. In general, it is also considered to be disadvantageous if the crop protection composition used spares the beneficial species but does kill all the pests. In this case, the survival base of the beneficial species is withdrawn since, for example, the food source or the host is missing, with the consequence that the beneficial species die, too.

Surprisingly, it has now been found that certain enaminocarbonyl compounds and certain beneficial species, namely microorganisms such as fungi (for example Metarhizium anisopliae or Beauveria bassiana) or bacteria or virus strains (for example Bacillus strains or baculoviruses such as granulosis viruses) and also insects and arachnids from the families of the Alloxystidae, Angstidae, Aphelinidae, Aphidiidae, Asilidae, Braconidae, Cantharidae, Carabidae, Cecidomyiidae, Chameiidae, Chrysopidae, Cleridae, Coccinellidae, Coniopterygidae, Encyrtidae, Eulophidae, Eumenidae, Euzetidae (soil mites), Forficulidae, Hemerobiidae, Ichneumonidae, Megaspilidae, Mymaridae, Phytoseiidae, Sphecidae, Staphylenidae, Stigmaeidae, Syrphidae, Tachnidae, Trichogrammatidae, Trombidiidae, Vespidae, predatory mites and nematodes can advantageously be used in combination in crop protection, in particular in the context of integrated crop protection, thus avoiding the disadvantages mentioned above.

Furthermore, it has been found that, using the combinations according to the invention of enaminocarbonyl compounds and beneficial species, applications of toxicologically and/or ecologically less favourable active compounds can be replaced while achieving a comparable activity, which is of benefit in particular for the safety of the user and/or the environment. Moreover, it has been found that spraying (i.e. the number of active compound applications per planting season) can be reduced. The combinations according to the invention of active compounds and beneficial species can be employed in the context of “Integrated Pest Management” (IPM) or “Integrated Crop Protection” programs and therefore make an important ecological contribution. Integrated Pest Management (IPM) is a strategy for controlling pests, which strategy comprises a number of complementing methods, inter alia biological and chemical methods. IPM is an ecological approach, the main aim of which is the reduction of the use of pesticides.

Accordingly, the invention relates to combinations of enaminocarbonyl compounds and beneficial species comprising an enaminocarbonyl compound according to the invention and at least one of the beneficial species mentioned above, in particular beneficial species selected from insects and arachnids of the families (1) to (21) as defined below.

The invention also relates to the use of combinations according to the invention of enaminocarbonyl compounds and beneficial species for controlling or combating plant pests, in particular in the context of Integrated Crop Protection (IPM) and a method for controlling or combating plant pests, characterized in that certain enaminocarbonyl compounds and at least one of the beneficial species mentioned above, in particular beneficial species selected from the insects and arachnids of families (1) to (21), are applied to the plants or parts of plants to be protected.

The particular enaminocarbonyl compounds which can be used in accordance with the invention have the formula (I)

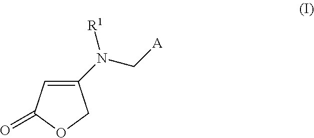

in which
R¹ represents alkyl, haloalkyl, alkenyl, haloalkenyl, alkynyl, cycloalkyl, cycloalkylalkyl, halocycloalkyl, alkoxy, alkoxyalkyl or halocycloalkylalkyl; and
A represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or represents 2-chloropyrazin-5-yl or represents 1,3-thiazol-5-yl which is optionally substituted in the 2-position by chlorine or methyl, or represents a radical pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulphonyl (which is optionally substituted by fluorine and/or chlorine), or represents a radical

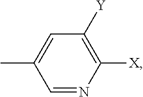

in which
X represents halogen, alkyl or haloalkyl,
Y represents halogen, alkyl, haloalkyl, haloalkoxy, azido or cyano.

Preferred enaminocarbonyl compounds are compounds of the formula (I) in which
R¹ represents optionally fluorine-substituted C₁-C₅-alkyl, C₂-C₅-alkenyl, C₃-C₅-cycloalkyl, C₃-C₅-cycloalkylalkyl or alkoxy, preferably methyl, methoxy, ethyl, propyl, vinyl, allyl, propargyl, cyclopropyl, 2-fluoroethyl, 2,2-difluoroethyl or 2-fluorocyclopropyl, particularly preferably methyl, cyclopropyl, methoxy, 2-fluoroethyl or 2,2-difluoroethyl, very particularly preferably methyl, 2-fluoro ethyl or 2,2-difluoroethyl; and
A represents 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl, 2-methyl-1,3-thiazol-5-yl, 2-chloropyrimidin-5-yl, 2-trifluormethylpyrimidin-5-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl, preferably the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl, 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl; particularly preferably the radical 6-fluoropyrid-3-yl, 6-chloropyrid-3-yl, 6-bromopyrid-3-yl, 5-fluoro-6-chloropyrid-3-yl, 2-chloro-1,3-thiazol-5-yl or 5,6-dichloropyrid-3-yl, very particularly preferably 6-chloropyrid-3-yl or 5-fluoro-6-chloropyrid-3-yl.

Enaminocarbonyl compounds which are likewise preferred are compounds of the formula (I) in which A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

Preference is furthermore given to compounds of the formula (I) in which R¹ represents methyl and A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

Preference is furthermore given to compounds of the formula (I) in which R¹ represents ethyl and A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

Preference is furthermore given to compounds of the formula (I) in which R¹ represents cyclopropyl and A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

Preference is furthermore given to compounds of the formula (I) in which R¹ represents 2-fluoroethyl and A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

Preference is furthermore given to compounds of the formula (I) in which R¹ represents 2,2-difluoroethyl and A represents 6-chloropyrid-3-yl, 6-bromopyrid-3-yl, 6-chloro-1,4-pyridazin-3-yl, 2-chloro-1,3-thiazol-5-yl, 5-fluoro-6-chloropyrid-3-yl, 5-fluoro-6-bromopyrid-3-yl or 5,6-dichloropyrid-3-yl.

In one embodiment, the invention relates to combinations of certain beneficial species and enaminocarbonyl compounds of the formula (I-a) and also to a combined application of certain beneficial species and enaminocarbonyl compounds of the formula (I-a)

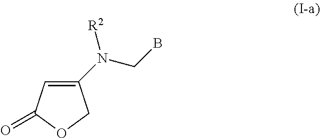

in which
R² represents haloalkyl, haloalkenyl, halocycloalkyl or halocycloalkylalkyl, preferably fluorine-substituted C₁-C₅-alkyl, C₂-C₅-alkenyl, C₃-C₅-cycloalkyl or C₃-C₅-cycloalkylalkyl, particularly preferably 2-fluoroethyl, 2,2-difluoroethyl or 2-fluorocyclopropyl, very particularly preferably 2-fluoroethyl or 2,2-difluoroethyl; and
B represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or represents 2-chloropyrazin-5-yl or represents 1,3-thiazol-5-yl which is optionally substituted in the 2-position by chlorine or methyl, B preferably represents 6-fluoropyrid-3-yl, 6-chloropyrid-3-yl, 6-bromopyrid-3-yl, 6-methylpyrid-3-yl, 6-trifluoro-methylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl, particularly preferably the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl, very particularly preferably the radical 6-chloropyrid-3-yl.

Enaminocarbonyl compounds which are likewise preferred are compounds of the formula (I-a) in which B represents 6-chloropyrid-3-yl, 6-bromopyrid-3-yl or 6-chloro-1,4-pyridazin-3-yl.

Preference is furthermore given to compounds of the formula (I-a) in which R² represents 2-fluoroethyl and B represents 6-chloropyrid-3-yl, 6-bromopyrid-3-yl or 6-chloro-1,4-pyridazin-3-yl.

Preference is furthermore given to compounds of the formula (I-a) in which R² represents 2,2-difluoroethyl and B represents 6-chloropyrid-3-yl, 6-bromopyrid-3-yl or 6-chloro-1,4-pyridazin-3-yl.

In one embodiment, the invention relates to combinations of certain beneficial species and enaminocarbonyl compounds of the formula (I-b) and also to a combined application of certain beneficial species and enaminocarbonyl compounds of the formula (I-b)

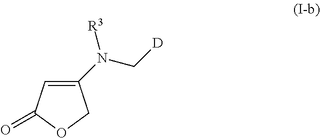

in which D represents a radical

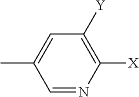

in which
X and Y have the meanings given above and
R³ represents hydrogen, alkyl, alkenyl, alkynyl, cycloalkyl or alkoxy.

Preference is given to compounds of the formula (I-b) in which
D represents one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl, preferably 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl, particularly preferably 5-fluoro-6-chloropyrid-3-yl or 5-fluoro-6-bromopyrid-3-yl, very particularly preferably 5-fluoro-6-chloropyrid-3-yl, and
R³ represents C₁-C₄-alkyl, C₂-C₄-alkenyl, C₂-C₄-alkynyl or C₃-C₄-cycloalkyl, preferably C₁-C₄-alkyl, particularly preferably methyl, ethyl, propyl, vinyl, allyl, propargyl or cyclopropyl, very particularly preferably methyl or cyclopropyl.

Enaminocarbonyl compounds which are likewise preferred are compounds of the formula (I-b) in which D represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-b) in which R³ represents methyl and D represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-b) in which R³ represents ethyl and D represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-b) in which R³ represents cyclopropyl and D represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

In one embodiment, the invention relates to combinations of certain beneficial species and enaminocarbonyl compounds of the formula (I-c) and also to a combined application of certain beneficial species and enaminocarbonyl compounds of the formula (I-c)

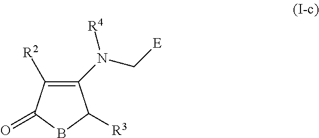

in which
E represents a radical

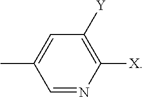

in which
X and Y have the meanings given above and
R⁴ represents haloalkyl, haloalkenyl, halocycloalkyl or halocycloalkylalkyl.

Preference is given to compounds of the formula (I-c) in which
E represents one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5 chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoro-methyl-6-chloropyrid-3-yl, 5-difluoromethyl-6-bromopyrid-3-yl, 5-difluoromethyl-6-iodopyrid-3-yl, preferably 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl, particularly preferably 5-fluoro-6-chloropyrid-3-yl; and
R⁴ represents fluorine-substituted C₁-C₅-alkyl, C₂-C₅-alkenyl, C₃-C₅-cycloalkyl or C₃-C₅-cycloalkylalkyl, preferably 2-fluoroethyl, 2,2-difluoroethyl, 2-fluorocyclopropyl, particularly preferably 2-fluoroethyl or 2,2-difluoroethyl.

Enaminocarbonyl compounds which are likewise preferred are compounds of the formula (I-c) in which E represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-c) in which R⁴ represents 2-fluoroethyl and E represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-c) in which R⁴ represents 2,2-difluoroethyl and E represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

Preference is furthermore given to compounds of the formula (I-c) in which R⁴ represents 2-fluoroethyl and E represents 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl or 5-chloro-6-iodopyrid-3-yl.

In one embodiment, the invention relates to combinations of certain beneficial species and enaminocarbonyl compounds of the formula (I-d) and also to a combined application of certain beneficial species and enaminocarbonyl compounds of the formula (I-d)

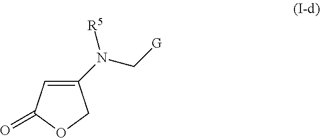

in which
G represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine, or methyl or represents pyrazin-3-yl or represents 2-chloropyrazin-5-yl or represents 1,3-thiazol-5-yl which is optionally substituted in the 2-position by chlorine or methyl; and
R⁵ represents C₁-C₄-alkyl, alkenyl, alkynyl, cycloalkyl or alkoxy.

Preference is given to compounds of the formula (I-d) in which
G represents 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl, preferably the radical 6-fluoropyrid-3-yl, 6-chloropyrid-3-yl, 6-bromopyrid-3-yl, 6-chloro-1,4-pyridazin-3-yl, 2-chloro-1,3-thiazol-5-yl, particularly preferably the radical 6-chloropyrid-3-yl; and
R⁵ represents C₁-C₄-alkyl, C₁-alkoxy, C₂-C₄-alkenyl, C₂-C₄-alkynyl or C₃-C₄-cycloalkyl, preferably methyl, methoxy, ethyl, propyl, vinyl, allyl, propargyl or cyclopropyl, particularly preferably methyl or cyclopropyl.

Enaminocarbonyl compounds which are likewise preferred are compounds of the formula (I-d) in which G represents 6-chloropyrid-3-yl, 6-bromopyrid-3-yl, 6-chloro-1,4-pyridazin-3-yl, 2-chloro-1,3-thiazol-5-yl, 6-fluoropyrid-3-yl, 6-trifluoromethylpyrid-3-yl or 6-fluoropyrid-3-yl.

Preference is furthermore given to compounds of the formula (I-d) in which R⁵ represents methyl and G represents 6-chloropyrid-3-yl, 6-bromopyrid-3-yl, 6-chloro-1,4-pyridazin-3-yl, 2-chloro-1,3-thiazol-5-yl, 6-fluoropyrid-3-yl, 6-trifluoromethylpyrid-3-yl or 6-fluoropyrid-3-yl.

Preference is furthermore given to compounds of the formula (I-d) in which R⁵ represents cyclopropyl and G represents 6-chloropyrid-3-yl, 6-bromopyrid-3-yl, 6-chloro-1,4-pyridazin-3-yl, 2-chloro-1,3-thiazol-5-yl, 6-fluoropyrid-3-yl, 6-trifluoromethylpyrid-3-yl or 6-fluoropyrid-3-yl.

According to the invention, particular preference is given to using the following enaminocarbonyl compounds in combination with the certain beneficial species:
4-{[(6-bromopyrid-3-yl)methyl](2-fluoroethyl)amino}furan-2(5H)-one (compound (I-1)) known from WO 2007/115644;
4-{[(6-fluoropyrid-3-yl)methyl](2,2-difluoroethyl)amino}furan-2(5H)-one (compound (I-2)) known from WO 2007/115644;
4-{[(2-chloro-1,3-thiazol-5-yl)methyl](2-fluoroethyl)amino}furan-2(5H)-one (compound (I-3)) known from WO 2007/115644;
4-{[(6-chloropyrid-3-yl)methyl](2-fluoroethyl)amino}furan-2(5H)-one (compound (I-4)) known from WO 2007/115644;
4-{[(6-chloropyrid-3-yl)methyl](2,2-difluoroethyl)amino}furan-2(5H)-one (compound (I-5)) known from WO 2007/115644;
4-{[(6-chloro-5-fluoropyrid-3-yl)methyl](methyl)amino}furan-2(5H)-one (compound (I-6)) known from WO 2007/115643;
4-{[(5,6-dichloropyrid-3-yl)methyl](2-fluoroethyl)amino}furan-2(5H)-one (compound (I-7)) known from WO 2007/115646;
4-{[(6-chloro-5-fluoropyrid-3-yl)methyl](cyclopropyl)amino}furan-2(5H)-one (compound (I-8)), known from WO 2007/115643;
4-{[(6-chloropyrid-3-yl)methyl](cyclopropyl)amino}furan-2(5H)-one (compound (I-9)), known from EP 0 539 588; and
4-{[(6-chloropyrid-3-yl)methyl](methyl)amino}furan-2(5H)-one (compound (I-10)) known from EP 0 539 588.

The compounds (I-1) to (I-10) have the following chemical structures:

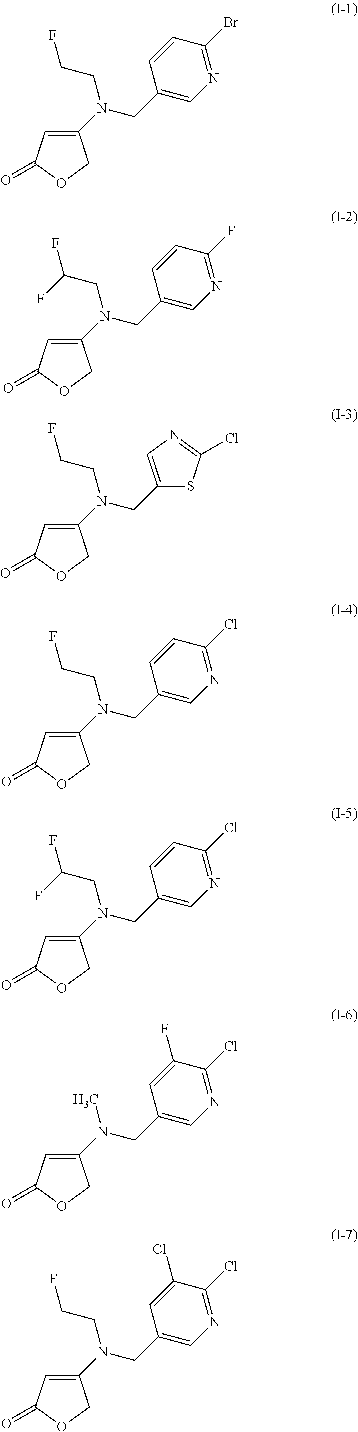

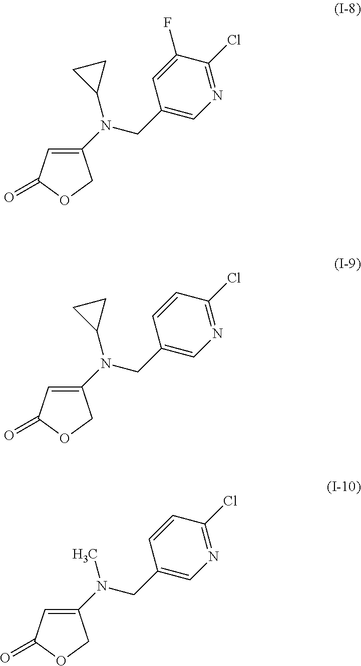

The enaminocarbonyl compounds according to the invention with at least one basic centre are capable of forming, for example, acid addition salts, for example with strong inorganic acids such as mineral acids, for example perchloric acid, sulphuric acid, nitric acid, nitrous acid, a phosphorus acid or a hydrohalic acid, with strong organic carboxylic acids such as unsubstituted or substituted, for example halogen-substituted, C₁-C₄-alkanecarboxylic acids, for example acetic acid, saturated or unsaturated dicarboxylic acids, for example oxalic acid, malonic acid, succinic acid, maleic acid, fumaric acid and phthalic acid, hydroxycarboxylic acids, for example ascorbic acid, lactic acid, malic acid, tartaric acid and citric acid, or benzoic acid, or with organic sulphonic acids such as unsubstituted or substituted, for example halogen-substituted, C₁-C₄-alkane- or arylsulphonic acids, for example methane- or p-toluenesulphonic acid. The enaminocarbonyl compounds according to the invention with at least one acidic group are capable of forming, for example, salts with bases, for example metal salts, such as alkali or alkaline-earth metal salts, for example sodium, potassium or magnesium salts, or salts with ammonia or an organic amine such as morpholine, piperidine, pyrrolidine, a lower mono-, di- or trialkylamine, for example, ethyl-, diethyl-, triethyl- or dimethylpropylamine, or a lower mono-, di- or trihydroxyalkylamine, for example mono-, di- or triethanolamine. Moreover, if appropriate, it may be possible for corresponding internal salts to be formed. In the context of the invention, agrochemically advantageous salts are preferred. Taking into consideration the close relationship between the compounds according to the invention in free form and in the form of their salts, any reference hereinabove and hereinbelow to the free compounds according to the invention or to their salts is to be interpreted such that, if appropriate and expedient, the corresponding salts or the free compounds according to the invention, respectively, are also included. This also applies to possible tautomers of the enaminocarbonyl compounds according to the invention and their salts.

The enaminocarbonyl compounds according to the invention can be prepared by known processes (see, for example, EP-A-0539588, WO 2006/037475, WO 2007/115643, WO 2007/115644 and WO 2007/115646).

The beneficial species (“certain beneficial species”) which can be used in the combination according to the invention are microorganisms such as fungi (for example Metarhizium anisopliae or Beauveria bassiana) or bacteria or virus strains (for example Bacillus strains or baculoviruses such as granulosis viruses) and also insects and arachnids from the families of the Alloxystidae, Angstidae, Aphelinidae, Aphidiidae, Asilidae, Braconidae, Cantharidae, Carabidae, Cecidomyiidae, Chameiidae, Chrysopidae, Cleridae, Coccinellidae, Coniopterygidae, Encyrtidae, Eulophidae, Eumenidae, Euzetidae (soil mites), Forficulidae, Hemerobiidae, Ichneumonidae, Megaspilidae, Mymaridae, Phytoseiidae, Sphecidae, Staphylenidae, Stigmaeidae, Syrphidae, Tachnidae, Trichogrammatidae, Trombidiidae, Vespidae, furthermore predatory mites and nematodes.

Preference is given to combinations of enaminocarbonyl compounds and beneficial species which comprise an enaminocarbonyl compound according to the invention and at least one beneficial species selected from the insects and arachnids of families (1) to (21) and which can be employed in particular for controlling and combating plant pests, advantageously in the context of integrated crop protection.

The following families (1) to (21) or family members can preferably be used as beneficial species according to the invention:

(1) from the family of the Eumenidae: Eumenes spp., Oplomerus spp.
(2) from the family of the Sphecidae: Ammophila sabulos, Cerceris arenaria.
(3) from the family of the Vespidae: Polistes spp. Vespa spp., Dolichovespula spp., Vespula spp., Paravespula spp.
(4) from the family of the Aphelinidae: Coccophagus spp., Encarsia spp., for example Encarsia formosa, Aphytis spp., Aphelinus spp., for example Aphelinus mali, Aphelinus abdominalis, Eretmocerus spp., for example Eretmocerus erimicus, Eretmocerus mundus, Prospaltella spp.
(5) from the family of the Trichogrammatidae: Trichogramma spp., for example Trichogamma brassicae.
(6) from the family of the Encyrtidae: Encyrtus fuscicollis, Aphidencyrtrus spp.
(7) from the family of the Mymaridae.
(8) from the family of the Ichneumoidae: Coccigomymus spp. Diadegma spp., Glypta spp., Ophion spp., Pimpla spp.
(9) from the family of the Eulophidae: Dyglyphus spp., for example Dyglyphus isaea, Eulophus viridula, Colpoclypeus florus.
(10) from the family of the Alloxystidae: Alloxysta spp.
(11) from the family of the Megaspilidae: Dendrocerus spp.
(12) from the family of the Braconidae: Aphidrus spp., Praon spp., Opius spp., Dacnusa spp., for example Dacnusa sibiria, Apanteles spp., Ascogaster spp., Macrocentrus spp.
(13) from the family of the Aphidiidae: Aphidius spp., for example Aphidius colemani, Aphidius ervi, Diaeretiella spp., Lysiphlebus spp.
(14) from the family of the Coccinellidae: Harmonia spp., Coccinella spp., for example Coccinella septempunctata, Adalia spp., for example Adalia bipunctata, Calvia spp., Chilocorus spp., for example Chilocorus bipustulatus, Scymnus spp., for example Scymnus abietes, Scymnus interruptus, Anatis spp., Rhizobius spp., Thea spp. Cryptolaemus spp., for example Cryptolaemus montrouzieri, Exochomus spp., Stethorus spp., for example Stethorus punctillum.
(15) from the family of the Staphylemidae: Aleochara spp., Aligota spp., Philonthus spp., Staphylinus spp.
(16) from the family of the Chrysopidae: Chrysopa spp., for example Chrysopa oculata, Chrysopa perla, Chrysopa carnea, Chrysopa flava, Chrysopa septempunctata, Chrysoperla.
(17) from the family of the Hemerobiidae: Hemerobius spp., for example Hemerobius fenestratus, Hemerobius humulinus, Hemerobius micans, Hemerobius nitidulus, Hemerobius pini, Wesmaelius spp., for example Wesmaelius nervosus.
(18) from the family of the Tachinidae: Bessa fugax, Cyzenius albicans, Compsileura concinnata, Elodia tragica, Exorista larvarum, Lyphia dubia.
(19) from the family of the Syrphidae: Dasysyrphus spp., Episyrphus balteatus, Melangyna triangulata, Melanostoma spp., Metasyrphus spp., Platycheirus spp., Syrphus spp.
(20) from the family of the Cecidomyiidae: Aphidoletes aphidimyza, Feltiella acarisuga.
(21) from the family of the Phytoseidae: Amblyseius spp., for example Amblyseius swirskii, Amblyseius cucumeris, Amblyseius degeneris, Amblyseius californicus, Thyphlodromus spp., for example Thyphlodromus pyri, Phytoseiulus spp., for example Phytoseiulus persimilis.

In addition, the combinations of enaminocarbonyl compounds and beneficial species may also comprise suitable added fungicidally, acaricidally or insecticidally active components.

From among the suitable beneficial species, preference according to the invention is given to beneficial species assigned to families (4), (9), (12), (13), (14), (16), (19), (20) and (21).

In one embodiment, the invention relates to combinations of enaminocarbonyl compounds and beneficial species comprising one of the enaminocarbonyl compounds (I-1) to (I-10) and at least one type of beneficial species selected from the insects and arachnids of families (1) to (21), in particular for controlling or combating plant pests, advantageously in the context of integrated crop protection.

In a further embodiment, the invention relates to a combination of enaminocarbonyl compounds and beneficial species comprising the enaminocarbonyl compound (I-5) and at least one type of beneficial species selected from the insects and arachnids of families (1) to (21), in particular for controlling or combating plant pests, advantageously in the context of integrated crop protection.

For the purpose of the present invention, the term “beneficial species” also includes certain fungi, for example Metarhizium anisopliae and Beauveria bassiana or microorganisms such as bacteria or virus strains, for example Bacillus thuringiensis strains or baculoviruses, for example granulosis viruses.

The insecticidal and/or acaricidal activity of the combinations according to the invention of active compounds and beneficial species is better than the activities of the individual active compound and the beneficial species on their own. There is an unforeseeable enhancement of activity.

For the purpose of the present invention, combinations of enaminocarbonyl compounds and beneficial species also include those combinations where the active compound and the beneficial species are applied at different times and/or locations. For example, the seed may be treated with the active compound and the beneficial species may be applied after sowing in the soil or after the emergence of the plant. It is also possible to use the active compound in the soil or on the leaf (“drench” or “foliar”) and to apply the beneficial species on the plant, or vice versa. Combinations according to the invention of active compounds and beneficial species are also present when the beneficial species is present on the plant even before the treatment, and the treatment with the active compound shifts the balance between harmful insects and beneficial species in favour of the beneficial species.

In one embodiment of the invention, combinations according to the invention of active compounds and beneficial species comprise at least one active enaminocarbonyl compound according to the invention and at least one fungus or microorganism.

The combinations according to the invention of enaminocarbonyl compounds and beneficial species can be used for protecting any plants and parts of plants. They are preferably used in annual crops such as, for example, vegetables, melons, ornamental plants, maize, but also in perennial plants such as, for example, citrus fruit, pome fruit and stone fruit, spices, conifers and other ornamental plants, and also in forests, particularly preferably in crops such as pome fruit, stone fruit, vegetables, ornamental plants, conifers and spices.

With respect to the use, vegetable is to be understood as meaning, for example, fruit vegetables and flower-heads as vegetables, for example bell peppers, chilli peppers, tomatoes, aubergines, cucumbers, cucurbits, courgettes, broad beans, runner beans, bush beans, peas, artichokes; but also leafy vegetables, for example lettuce, chicory, endives, cress, rocket salad, field salad, iceberg lettuce, leek, spinach, Swiss chard; furthermore tuber vegetables, root vegetables and stem vegetables, for example celeriac, beetroot, carrots, garden radish, horseradish, scorzonera, asparagus, table beet, palm shoots, bamboo shoots, moreover bulb vegetables, for example onions, leek, fennel, garlic; furthermore brassica vegetables, such as cauliflowers, broccoli, kohlrabi, red cabbage, white cabbage, green cabbage, Savoy cabbage, Brussels sprouts, Chinese cabbage.

In the context of the present invention, perennial crops are to be understood as meaning citrus fruit, such as, for example, oranges, grapefruits, mandarins, lemons, limes, bitter oranges, cumquats, satsumas; but also pome fruit, such as, for example, apples, pears and quince, and stone fruit, such as, for example, peaches, nectarines, cherries, plums, common plums, apricots; furthermore grapevine, hops, olives, tea, and tropical crops, such as, for example, mangoes, papayas, figs, pineapples, dates, bananas, durians, kakis, coconuts, cacao, coffee, avocados, lychees, maracujas, guavas, moreover almonds and nuts, such as, for example, hazelnuts, walnuts, pistachios, cashew nuts, brazil nuts, pecan nuts, butter nuts, chestnuts, hickory nuts, macadamia nuts, peanuts, additionally also soft fruit, such as, for example, blackcurrants, gooseberries, raspberries, blackberries, blueberries, strawberries, red bilberries, kiwis, cranberries.

In the context of the present invention, ornamental plants are to be understood as meaning annual and perennial plants, for example cut flowers, such as, for example, roses, carnations, gerbera, lilies, marguerites, chrysanthemums, tulips, daffodils, anemones, poppies, amaryllis, dahlias, azaleas, malves, but also, for example, bedding plants, potted plants and shrubs, such as, for example, roses, tagetes, pansies, geraniums, fuchsias, hibiscus, chrysanthemums, busy lizzies, cyclamen, African violets, sunflowers, begonias, furthermore, for example, bushes and conifers, such as, for example, fig trees, rhododendron, spruce trees, fir trees, pine trees, yew trees, juniper trees, stone pines, rose bays.

In the context of the present invention, spices are understood as meaning annual and perennial plants such as, for example, aniseed, chilli pepper, paprika, pepper, vanilla, marjoram, thyme, cloves, juniper berries, cinnamon, tarragon, coriander, saffron, ginger.

When using the combinations according to the invention of active compounds and beneficial species as insecticides and acaricides, the application rates of the enaminocarbonyl compounds can be varied within a relatively wide range, depending on the kind of application. When treating plant parts, for example leaves, the application rate of the enaminocarbonyl compounds according to the invention is from 0.1 to 10 000 g/ha, preferably from 1 to 1 000 g/ha, particularly preferably from 10 to 300 g/ha (if the application is by watering or dripping, it may even be possible to reduce the application rate, especially when inert substrates such as rock wool or perlite are used).

These application rates are mentioned only by way of example and are not limiting in the sense of the invention.

The combinations according to the invention of enaminocarbonyl compound and beneficial species can be used to protect plants for a certain period after the treatment against attack by the animal pests mentioned. The period for which protection is provided extends generally for 1 to 28 days, preferably for 1 to 14 days, particularly preferably for 1 to 10 days, very particularly preferably for 1 to 7 days after the treatment of the plants with the combinations of enaminocarbonyl compound and beneficial species.

As already mentioned, the combinations according to the invention of active compounds and beneficial species are suitable for protecting plants and plant parts, in particular for controlling or combating pests such as insects and arachnids, helminths, nematodes and molluscs encountered in agriculture, in horticulture, in forests, in gardens and in leisure facilities. They are preferably employed as crop protection compositions.

The active compounds according to the invention can be converted into the customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active compound, synthetic substances impregnated with active compound, fertilizers and also microencapsulations in polymeric substances.

These formulations are produced in a known manner, for example by mixing the active compounds with extenders, that is, liquid solvents and/or solid carriers, optionally with the use of surfactants, that is to say emulsifiers and/or dispersants and/or foam-formers. The formulations are prepared either in suitable facilities or else before or during application.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatic hydrocarbons and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

According to the invention, a carrier is a natural or synthetic, organic or inorganic substance which may be solid or liquid and with which the active compounds are mixed or bonded for better applicability, in particular for application to plants or plant parts or seed. The solid or liquid carrier is generally inert and should be suitable for use in agriculture.

Suitable solid or liquid carriers are: for example ammonium salts and ground natural minerals such as kaolins, clays, talc, chalk, quartz, attapulgite, montmorillonite or diatomaceous earth, and ground synthetic materials such as highly disperse silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligomers or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and also their adducts with formaldehyde.

Tackifiers such as carboxymethylcellulose and natural and synthetic polymers in the form of powders, granules or lattices, such as gum arabic, polyvinyl alcohol and polyvinyl acetate, as well as natural phospholipids such as cephalins and lecithins, and synthetic phospholipids, can be used in the formulations. It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc. Other possible additives are perfumes, mineral or vegetable oils which are optionally modified, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability, may also be present.

The active compound content of the use forms prepared from the commercially available formulations can vary within wide limits. The total active compound concentration, or the active compound concentration of the individual active compounds of the use forms is in the range of from 0.00000001 to 97% by weight of active compound, preferably in the range of from 0.0000001 to 97% by weight, particularly preferably in the range of from 0.000001 to 83% by weight or 0.000001 to 5% by weight, and very particularly preferably in the range of from 0.0001 to 1% by weight.

The combinations according to the invention of active compounds and beneficial species can be present in their commercially available formulations and in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals.

A mixture with other known active compounds, such as herbicides, fertilizers, growth regulators, safeners, semiochemicals, or else with agents for improving the plant properties, is also possible.

When used as insecticides, the combinations according to the invention of enaminocarbonyl compounds and beneficial species can furthermore be present in their commercially available formulations and in the use forms, prepared from these formulations, as a mixture with synergistic agents. Synergists are compounds which increase the action of the active compounds, without it being necessary for the synergist added to be active itself.

When used as insecticides, the combinations according to the invention of enaminocarbonyl compounds and beneficial species can furthermore be present in their commercially available formulations and in the use forms, prepared from these formulations, as a mixture with inhibitors which reduce degradation of the active compound after use in the environment of the plant, on the surface of parts of plants or in plant tissues.

The compounds are employed in a customary manner appropriate for the use forms.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. The plant parts also include harvested material and also vegetative and generative propagation material, for example fruits, seeds, cuttings, tubers, rhizomes, slips, seed, bulbils, layers and runners.

Treatment according to the invention of the plants and plant parts with the combinations of active compounds and beneficial species is carried out directly or by allowing the compounds to act on their surroundings, environment or storage space by the customary treatment methods, for example by immersion, spraying, evaporation, fogging, scattering, painting on, injection and, in the case of propagation material, in particular in the case of seeds, also by applying one or more coats.

The combinations of active compounds and beneficial species according to the invention are particularly suitable for protecting plants immediately after germination. This phase is particularly critical since the roots and shoots of the growing plant are particularly sensitive and even minor damage can lead to the death of the whole plant. Protecting the seed and the germinating plant by the use of suitable compositions is therefore of particularly great interest.

The present invention relates in particular also to a method where the seed is treated with the active compound according to the invention and the beneficial species is used after sowing in the soil or after the emergence of the plant. The present invention relates in particular also to a method where the seed is treated with the active compound according to the invention and the beneficial species is already present in the soil during sowing or after the emergence of the plant, and where the treatment with the active compound shifts the balance between harmful insects and beneficial species in favour of the beneficial species.

One of the advantages of the present invention is that the particular systemic properties of some of the active compounds mean that treatment of the seed with these active compounds not only protects the seed itself, but also the resulting plants after emergence, from pests. In this manner, the immediate treatment of the crop at the time of sowing or shortly thereafter can be dispensed with.

Furthermore, it must be considered as advantageous that the combinations according to the invention of active compounds and beneficial species can also be employed in particular in transgenic seed, the plants arising from this seed being capable of expressing a protein directed against pests. By using the active compound according to the invention, certain pests can be controlled merely by the expression of the, for example, insecticidal protein, and additionally damage to the seed may be averted by the combinations according to the invention of active compounds and beneficial species.

The combinations according to the invention of active compounds and beneficial species are suitable for use with seed of any plant variety which is employed in agriculture, in the greenhouse, in forests or in horticulture. In particular, this takes the form of seed of maize, peanut, canola, oilseed rape, poppy, soya beans, cotton, beet (for example sugar beet and fodder beet), rice, millet, wheat, barley, oats, rye, sunflower, tobacco, potatoes or vegetables (for example tomatoes, cabbage species). The combinations according to the invention of active compounds and beneficial species are furthermore suitable for use and for protecting the seed of the plant developing therefrom (emerging plant) of fruit plants and vegetables. The protection of the seed of the plant developing therefrom (emerging plant) of maize, soya beans, cotton, wheat and canola or oilseed rape is of particular importance.

As already mentioned above, the protection of transgenic seed and the plant developing therefrom (emerging plant) is also of particular importance. This takes the form of seed of plants which, as a rule, comprise at least one heterologous gene which governs the expression of a polypeptide with in particular insecticidal properties. In this context, the heterologous genes in transgenic seed may be derived from microorganisms such as Bacillus, Rhizobium, Pseudomonas, Serratia, Trichoderma, Clavibacter, Glomus or Gliocladium. The present invention is particularly suitable for the treatment of transgenic seed which comprises at least one heterologous gene originating from Bacillus sp. and whose gene product shows activity against the European corn borer and/or the corn root worm. It is particularly preferably a heterologous gene derived from Bacillus thuringiensis.

Within the context of the present invention, the active compound according to the invention is applied to the seed either alone or in a suitable formulation. Preferably, the seed is treated in a state in which it is stable enough to avoid damage during treatment. In general, the seed may be treated at any point in time between harvest and sowing. The seed usually used has been separated from the plant and freed from cobs, shells, stalks, coats, hairs or the flesh of the fruits.

When treating the seed, care must generally be taken that the amount of the active compound applied to the seed and/or the amount of further additives is chosen in such a way that the germination of the seed is not adversely affected, or that the resulting plant is not damaged. This must be borne in mind in particular in the case of active compounds which can have phytotoxic effects at certain application rates.

The active compound according to the invention can be applied directly, i.e. without containing any other components and undiluted. In general, it is preferred to apply the active compound to the seed in the form of a suitable formulation. Suitable formulations and methods for treating seed are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active compounds which can be used in accordance with the invention can be converted into the customary seed-dressing formulations, such as solutions, emulsions, suspensions, powders, foams, slurries or other coating compositions for seed, and also ULV formulations.

These formulations are prepared in a known manner, by mixing the active compounds with customary additives such as, for example, customary extenders and also solvents or diluents, colorants, wetting agents, dispersants, emulsifiers, antifoams, preservatives, secondary thickeners, adhesives, gibberellins and also water.

Colorants which may be present in the seed-dressing formulations which can be used in accordance with the invention are all colorants which are customary for such purposes. In this context, not only pigments, which are sparingly soluble in water, but also dyes, which are soluble in water, may be used. Examples which may be mentioned are the colorants known by the names Rhodamin B, C.I. Pigment Red 112 and C.I. Solvent Red 1.

Suitable wetting agents which may be present in the seed-dressing formulations which can be used in accordance with the invention are all substances which promote wetting and which are conventionally used for the formulation of agrochemical active compounds. Preference is given to using alkylnaphthalenesulphonates, such as diisopropyl- or diisobutylnaphthalenesulphonates.

Suitable dispersants and/or emulsifiers which may be present in the seed-dressing formulations which can be used in accordance with the invention are all nonionic, anionic and cationic dispersants conventionally used for the formulation of agrochemical active compounds. Preference is given to using nonionic or anionic dispersants or mixtures of nonionic or anionic dispersants. Suitable nonionic dispersants which may be mentioned are, in particular, ethylene oxide/propylene oxide block polymers, alkylphenol polyglycol ethers and tristryrylphenol polyglycol ethers, and their phosphated or sulphated derivatives. Suitable anionic dispersants are, in particular, lignosulphonates, polyacrylic acid salts and arylsulphonate/formaldehyde condensates.

Antifoams which may be present in the seed-dressing formulations which can be used in accordance with the invention are all foam-inhibiting substances conventionally used for the formulation of agrochemical active compounds. Silicone antifoams and magnesium stearate can preferably be used.

Preservatives which may be present in the seed-dressing formulations which can be used in accordance with the invention are all substances which can be employed for such purposes in agrochemical compositions. Dichlorophene and benzyl alcohol hemiformal may be mentioned by way of example.

Secondary thickeners which may be present in the seed-dressing formulations which can be used in accordance with the invention are all substances which can be employed for such purposes in agrochemical compositions. Cellulose derivatives, acrylic acid derivatives, xanthan, modified clays and finely divided silica are preferred.

Adhesives which may be present in the seed-dressing formulations which can be used in accordance with the invention are all customary binders which can be employed in seed-dressing products. Polyvinylpyrrolidone, polyvinyl acetate, polyvinyl alcohol and tylose may be mentioned as being preferred.

Gibberellins which can be present in the seed-dressing formulations which can be used in accordance with the invention are preferably the gibberellins A1, A3 (=gibberellic acid), A4 and A7; gibberellic acid is especially preferably used. The gibberellins are known (cf. R. Wegler “Chemie der Pflanzenschutz- and Schädlingsbekämpfungsmittel” [Chemistry of crop protection agents and pesticides], vol. 2, Springer Verlag, 1970, p. 401-412).

The seed-dressing formulations which can be used in accordance with the invention can be employed for the treatment of a wide range of seed, including the seed of transgenic plants, either directly or after previously having been diluted with water. In this context, additional synergistic effects may also occur in cooperation with the substances formed by expression.

All mixers which can conventionally be employed for the seed-dressing operation are suitable for treating seed with the seed-dressing formulations which can be used in accordance with the invention or with the preparations prepared therefrom by addition of water. Specifically, a procedure is followed during the seed-dressing operation in which the seed is placed into a mixer, the specific desired amount of seed-dressing formulations, either as such or after previously having been diluted with water, is added, and everything is mixed until the formulation is distributed uniformly on the seed. If appropriate, this is followed by a drying process.

In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering, such as, for example, antisense or cosuppression technology, RNA interference—RNAi—technology, if appropriate in combination with conventional methods (Genetically Modified Organisms), and parts thereof are treated. The terms “parts” or “parts of plants” or “plant parts” have been explained above.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or with the aid of recombinant DNA techniques. Crop plants can thus be plants which can be obtained by conventional breeding and optimization methods or by biotechnological and genetic engineering methods or combinations of these methods, including the transgenic plants and including the plant varieties which can or cannot be protected by varietal property rights.

The method of treatment according to the invention can therefore also be used in the treatment of genetically modified organisms (GMOs), e.g. plants or seeds. Genetically modified plants (or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example antisense technology, cosuppression technology or RNAi technology [RNA interference]). A heterologous gene that is located in the genome is also called a transgene. A transgene that is defined by its particular location in the plant genome is called a transformation or transgenic event. Depending on the plant species or plant varieties, their location and growth conditions (soils, climate, vegetation period, diet), the treatment according to the invention may also result in superadditive (“synergistic”) effects. Possible are thus, for example, the following effects which exceed the effects which were actually to be expected: reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf colour, earlier flowering, higher quality and/or a higher nutritional value of the harvested products, higher sugar concentration within the fruits, better storage stability and/or processability of the harvested products.

At certain application rates, the combinations according to the invention of active compounds and beneficial species may also have a strengthening effect on plants. Accordingly, they are suitable for mobilizing the defence system of the plant against attack by unwanted phytopathogenic fungi and/or microorganisms and/or viruses. This may, if appropriate, be one of the reasons for the enhanced activity of the combinations according to the invention, for example against fungi. Plant-strengthening (resistance-inducing) substances are to be understood as meaning, in the present context, also those substances or combinations of substances which are capable of stimulating the defence system of plants in such a way that, when subsequently inoculated with unwanted phytopathogenic fungi and/or microorganisms and/or viruses, the treated plants display a substantial degree of resistance to these unwanted phytopathogenic fungi and/or microorganisms and/or viruses. In the present case, unwanted phytopathogenic fungi and/or microorganisms and/or viruses are understood as meaning phytopathogenic fungi, bacteria and viruses. Thus, the substances according to the invention can be employed for protecting plants against attack by the abovementioned pathogens within a certain period of time after the treatment. The period within which protection is brought about generally extends from 1 to 10 days, preferably 1 to 7 days, after the treatment of the plants with the combinations of active compounds and beneficial species.

Plants and plant varieties which are preferably to be treated according to the invention include all plants which have genetic material which imparts particularly advantageous, useful traits to these plants (whether obtained by breeding and/or biotechnological means). Plants and plant varieties which are also preferably treated according to the invention are resistant against one or more biotic stress factors, i.e. said plants have a better defence against animal and microbial pests, such as against nematodes, insects, mites, phytopathogenic fungi, bacteria, viruses and/or viroids.

Plants and plant varieties which may also be treated according to the invention are those plants which are resistant to one or more abiotic stress factors. Abiotic stress conditions may include, for example, drought, cold temperature exposure, heat exposure, osmotic stress, waterlogging, increased soil salinity, increased exposure to minerals, exposure to ozone, exposure to strong light, limited availability of nitrogen nutrients, limited availability of phosphorus nutrients or shade avoidance.

Plants and plant varieties which may also be treated according to the invention are those plants characterized by enhanced yield characteristics. Enhanced yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability. Plants which can be treated according to the invention are hybrid plants which already express the properties of heterosis and the hybrid effect, which generally leads to higher yield, higher growth, better health effect, better resistance to biotic and abiotic stress factors. Such plants are typically made by crossing an inbred male-sterile parent line (the female parent) with another inbred male-fertile parent line (the male parent). Hybrid seed is typically harvested from the male-sterile plants and sold to growers. Male-sterile plants can sometimes (e.g. in corn) be produced by detasseling (i.e. the mechanical removal of the male reproductive organs or male flowers) but, more typically, male sterility is the result of genetic determinants in the plant genome. In that case, and especially when seed is the desired product to be harvested from the hybrid plants, it is typically useful to ensure that male fertility in the hybrid plants, which contain the genetic determinants responsible for male sterility, is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described for Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar (e.g. WO 1991/002069). Plants or plant varieties (obtained by plant biotechnology methods, such as genetic engineering) which can be treated according to the invention are herbicide tolerant plants, i.e. plants which have been made tolerant to one or more prescribed herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants which have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species for example). Plants expressing an exogenous phosphinothricin acetyltransferase have been described, for example, in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that have been made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated HPPD enzyme according to WO 1996/038567, WO 1999/024585 and WO 1999/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS inhibitors include, for example, sulphonylurea, imidazolinone, triazolopyrimidines, pyrimidinyl oxy(thio)benzoates, and/or sulphonylaminocarbonyltriazolinone herbicides. Different mutations in the ALS enzyme (also known as acetohydroxy acid synthase, AHAS) are known to confer tolerance to different herbicides and groups of herbicides, as described, for example, in Tranel and Wright, Weed Science (2002), 50, 700-712, and also in U.S. Pat. No. 5,605,011, U.S. Pat. No. 5,378,824, U.S. Pat. No. 5,141,870 and U.S. Pat. No. 5,013,659. The production of sulphonylurea-tolerant plants and imidazolinone-tolerant plants has been described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and also in the international publication WO 1996/033270. Further imidazolinone-tolerant plants have also been described, for example in WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants have also been described, for example in WO 2007/024782.

Other plants tolerant to imidazolinone and/or sulphonylurea can be obtained by induced mutagenesis, by selection in cell cultures in the presence of the herbicide or by mutation breeding, as described, for example, for soya beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant varieties (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance. In the present context, the term “insect-resistant transgenic plant” includes any plant containing at least one transgene comprising a coding sequence encoding: 1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) in the Bacillus thuringiensis toxin nomenclature, online at: http://www.lifesci.sussex.ac.uk/Home/Neil_Crickmore/Bt/), or insecticidal portions thereof, for example proteins of the Cry protein classes Cry1Ab, Cry1Ac, Cry1F, Cry2Ab, Cry3Ae or Cry3Bb or insecticidal portions thereof; or 2) a crystal protein from Bacillus thuringiensis or a portion thereof which is insecticidal in the presence of a second other crystal protein than Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm. Microb. (2006), 71, 1765-1774); or 3) a hybrid insecticidal protein comprising parts of two different insecticidal crystal proteins from Bacillus thuringiensis, such as a hybrid of the proteins of 1) above or a hybrid of the proteins of 2) above, for example the Cry1A.105 protein produced by maize event MON98034 (WO 2007/027777); or 4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR 604; or 5) an insecticidal secreted protein from Bacillus thuringiensis or Bacillus cereus, or an insecticidal portion thereof, such as the vegetative insecticidal proteins (VIP) listed at: http://www.lifesci.sussex.ac.uk/home/Neil_Crickmore/Bt/vip.html, for example proteins from the VIP3Aa protein class; or 6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or 7) a hybrid insecticidal protein comprising parts from different secreted proteins from Bacillus thuringiensis or Bacillus cereus, such as a hybrid of the proteins in 1) above or a hybrid of the proteins in 2) above; or 8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT 102.

Of course, insect-resistant transgenic plants, as used herein, also include any plant comprising a combination of genes encoding the proteins of any one of the above classes 1 to 8. In one embodiment, an insect-resistant plant contains more than one transgene encoding a protein of any one of the above classes 1 to 8, to expand the range of target insect species affected or to delay insect resistance development to the plants, by using different proteins insecticidal to the same target insect species but having a different mode of action, such as binding to different receptor binding sites in the insect.

Plants or plant varieties (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include the following:
a. plants which contain a transgene capable of reducing the expression and/or the activity of the poly(ADP-ribose)polymerase (PARP) gene in the plant cells or plants, as described in WO 2000/004173 or EP 04077984.5 or EP 06009836.5.
b. plants which contain a stress tolerance-enhancing transgene capable of reducing the expression and/or the activity of the PARG encoding genes of the plants or plant cells, as described, for example, in WO 2004/090140; c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyl transferase, nicotinamide adenine dinucleotide synthetase or nicotinamide phosphoribosyltransferase, as described, for example, in the European Patent Application No. 04077624.7 or WO 2006/133827 or PCT/EP07/002,433.

Plants or plant varieties (obtained by plant biotechnology methods such as genetic engineering) which may also be treated according to the invention show altered quantity, quality and/or storage stability of the harvested product and/or altered properties of specific ingredients of the harvested product such as, for example:
1) Transgenic plants which synthesize a modified starch which is altered with respect to its chemophysical traits, in particular the amylose content or the amylose/amylopectin ratio, the degree of branching, the average chain length, the distribution of the side chains, the viscosity behaviour, the gel resistance, the grain size and/or grain morphology of the starch in comparison to the synthesized starch in wild-type plant cells or plants, such that this modified starch is better suited for certain applications. These transgenic plants synthesizing a modified starch are described, for example, in EP 0571427, WO 1995/004826, EP 0719338, WO 1996/15248, WO 1996/19581, WO 1996/27674, WO 1997/11188, WO 1997/26362, WO 1997/32985, WO 1997/42328, WO 1997/44472, WO 1997/45545, WO 1998/27212, WO 1998/40503, WO 99/58688, WO 1999/58690, WO 1999/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, U.S. Pat. No. 6,734,341, WO 2000/11192, WO 1998/22604, WO 1998/32326, WO 2001/98509, WO 2001/98509, WO 2005/002359, U.S. Pat. No. 5,824,790, U.S. Pat. No. 6,013,861, WO 1994/004693, WO 1994/009144, WO 1994/11520, WO 1995/35026 and WO 1997/20936.
2) Transgenic plants which synthesize non-starch carbohydrate polymers or which synthesize non-starch carbohydrate polymers with altered properties in comparison to wild-type plants without genetic modification. Examples are plants which produce polyfructose, especially of the inulin and levan type, as described in EP 0663956, WO 1996/001904, WO 1996/021023, WO 1998/039460 and WO 1999/024593, plants which produce alpha-1,4-glucans, as described in WO 1995/031553, US 2002/031826, U.S. Pat. No. 6,284,479, U.S. Pat. No. 5,712,107, WO 1997/047806, WO 1997/047807, WO 1997/047808 and WO 2000/14249, plants which produce alpha-1,6-branched alpha-1,4-glucans, as described in WO 2000/73422, and plants which produce alternan, as described in WO 2000/047727, EP 06077301.7, U.S. Pat. No. 5,908,975 and EP 0728213.
3) Transgenic plants which produce hyaluronan, as described, for example, in WO 2006/032538, WO 2007/039314, WO 2007/039315, WO 2007/039316, JP 2006/304779 and WO 2005/012529.

Plants or plant varieties (obtained by plant biotechnology methods such as genetic engineering) which may also be treated according to the invention are plants, such as cotton plants, with altered fibre characteristics. Such plants can be obtained by genetic transformation, or by selection of plants containing a mutation imparting such altered fibre characteristics and include:
a) plants, such as cotton plants, which contain an altered form of cellulose synthase genes, as described in WO 1998/000549;
b) plants, such as cotton plants, which contain an altered form of rsw2 or rsw3 homologous nucleic acids, as described in WO 2004/053219;
c) plants, such as cotton plants, with an increased expression of sucrose phosphate synthase, as described in WO 2001/017333;
d) plants, such as cotton plants, with an increased expression of sucrose synthase, as described in WO 02/45485;
e) plants, such as cotton plants, wherein the timing of the plasmodesmatal gating at the basis of the fibre cell is altered, for example through downregulation of fibre-selective β-1,3-glucanase, as described in WO 2005/017157;
f) plants, such as cotton plants, which have fibres with altered reactivity, for example through the expression of the N-acetylglucosaminetransferase gene including nodC and chitin synthase genes, as described in WO 2006/136351.

Plants or plant cultivars (obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:
a) plants, such as oilseed rape plants, which produce oil having a high oleic acid content, as described, for example, in U.S. Pat. No. 5,969,169, U.S. Pat. No. 5,840,946 or U.S. Pat. No. 6,323,392 or U.S. Pat. No. 6,063,947;
b) plants, such as oilseed rape plants, which produce oil having a low linolenic acid content, as described in U.S. Pat. No. 6,270,828, U.S. Pat. No. 6,169,190 or U.S. Pat. No. 5,965,755;
c) plants, such as oilseed rape plants, which produce oil having a low level of saturated fatty acids, as described, for example, in U.S. Pat. No. 5,434,283.

Particularly useful transgenic plants which may be treated according to the invention are plants which comprise one or more genes which encode one or more toxins and are the transgenic plants available under the following trade names: YIELD GARD® (for example maize, cotton, soya beans), KnockOut® (for example maize), BiteGard® (for example maize), BT-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soya bean varieties which are available under the following trade names: Roundup Ready® (tolerance to glyphosate, for example maize, cotton, soya beans), Liberty Link® (tolerance to phosphinothricin, for example oilseed rape), IMI® (tolerance to imidazolinone) and SCS® (tolerance to sulphonylurea, for example maize). Herbicide-resistant plants (plants bred in a conventional manner for herbicide tolerance) which may be mentioned include the varieties sold under the name Clearfield® (for example maize).

Particularly useful transgenic plants which may be treated according to the invention are plants containing transformation events, or a combination of transformation events, and that are listed for example in the databases for various national or regional regulatory agencies (see for example http://gmoinfo.jrc.it/gmp_browse.aspx and http://www.agbios.com/dbase.php).

In the field of household insecticides, they are used alone or in combination with other suitable active compounds, such as phosphoric acid esters, carbamates, pyrethroids, neonicotinoids, growth regulators or active compounds from other known classes of insecticides.

They are used in aerosols, pressure-free spray products, for example pump and atomizer sprays, automatic fogging systems, foggers, foams, gels, evaporator products with evaporator tablets made of cellulose or plastic, liquid evaporators, gel and membrane evaporators, propeller-driven evaporators, energy-free, or passive, evaporation systems, moth papers, moth bags and moth gels, as granules or dusts, in baits for spreading or in bait stations.

The good insecticidal and acaricidal action of the combinations according to the invention of active compounds and beneficial species can be seen from the examples which follow. While the individual active compounds or beneficial species show weaknesses in their action, the combinations show an action which exceeds a simple sum of actions.

The invention is illustrated by the examples below without being limited thereto.

### BIOLOGICAL EXAMPLES

Unless indicated otherwise, use was made of the active compound solutions below, where the active compound in its respective formulation was brought to the required concentration by dilution with water.

Foliar treatment is carried out using compound (I-5) in a concentration of 75 g of active compound per hectare.

Drench treatment is carried out using compound (I-5) in a concentration of 10 mg of active compound per plant.

Foliar treatment with Karate Zeon CS100 as toxic control was carried out in a concentration of 12.5 g of active compound per hectare.

### 1. Larvae Treatment—Coccinella

Beneficial species: Coccinella septempunctata L2 larvae
Pest: Myzus persicae

Each experiment is carried out in 3 repetitions with in each case 2 pot cages with in each case 5 larvae.

For the experiment, Savoy cabbage plants are grown in pots having a diameter of 14 cm, placed in a breeding cage and infested thoroughly with Myzus persicae. Per experiment, 6 pots having a well-established aphid population are selected and the aphids are rated by estimation of their number. The plants are treated with the active compound solution of the appropriate concentration.

After the spray coating has dried on, a quartz sand layer of a thickness of about 1 cm is applied to the soil in the pot, and the pot cage is put over the plant. In each case 5 Coccinella larvae are then counted out, and in each case 5 specimen are added to the plants in the pot cage.

For each plant, at the beginning the Myzus persicae number is estimated at the appropriate points in time and the dead, dying and alive larvae are counted separately. All larvae, i.e. all larvae present on the plant and the surface of the quartz sand base, are counted.

The experimental results, averaged over 3 repetitions, are listed in the table below:

| | Infestation by Myzus persicae | |
|---|---|---|
| | (number per plant) | |
| Treatment | prior to application | 5 days after application |
| control (without active | 557 | 443 |
| compound) | | |
| compound (I-5) foliar | 602 | 0 |
| compound (I-5) drench | 552 | 165 |
| Karate Zeon CS100 | 571 | 0 |

| | Number of Coccinella | | | |
|---|---|---|---|---|
| | septempunctata larvae on 6 Savoy | | | |
| | cabbage plants (control) or kill [% Abbott] | | | |
| | 0 days after | 1 day after | 3 days after | 5 days after |
| Treatment | application | application | application | application |
| control | 60 | 60 | 59 | 58 |
| (without active | | | | |
| compound) | | | | |
| compound | 0% | 3.3% | 1.7% | 6.9% |
| (I-5) foliar | | | | |
| compound | 0% | 1.7% | 1.7% | 3.4% |
| (I-5) drench | | | | |
| Karate Zeon | 0% | 61.7% | 91.5% | 98.3% |
| CS100 | | | | |

### 2. Larvae Treatment—Aphidoletes

Beneficial species: Aphidoletes aphidimyza larvae
Pest: Myzus persicae

Each experiment is carried out in 3 repetitions.

Per plot, 6 Savoy cabbage plants are placed into a planting-out tray and infested with Myzus persicae. About 1 week later, with a well-established Myzus population, the Aphidoletes aphidimyza are added. The application is carried after about 2 weeks once sufficient L2 stage Aphidoletes larvae are present (at least 20 larvae per tray).

In preparation for the application, the plants are reduced to 4 healthy green leaves.

Immediately prior to the application, the Myzus population and the number of Aphidoletes larvae are rated. For the application, all 6 plants of a plot are placed onto the turntable, and the amount of spray liquor for 0.666 m² is applied while turning slowly. After the application, the trays are placed into the standard cages.

For each plant, the number of Myzus persicae is estimated at the beginning at the appropriate points in time, and the larvae are counted accurately.

The experimental results, averaged over 3 repetitions, are listed in the table below:

| | Infestation by Myzus persicae (number per plant) | |
|---|---|---|
| Treatment | prior to application | 5 days after application |
| control (without active | 352 | 271 |
| compound) | | |
| compound (I-5) foliar | 344 | 0 |
| compound (I-5) drench | 367 | 19.4 |
| Karate Zeon CS100 | 344 | 0 |

| | Number of Aphidoteles aphidimyza larvae on 6 Savoy | | | |
|---|---|---|---|---|
| | cabbage plants (control) or kill [% Abbott] | | | |
| | 0 days after | 1 day after | 3 days after | 5 days after |
| Treatment | application | application | application | application |
| control | 75 | 72 | 70 | 68 |
| (without active | | | | |
| compound) | | | | |
| compound | 0% | 10.2% | 10.5% | 15.2% |
| (I-5) foliar | | | | |
| compound | 0% | 3.2% | 4.3% | 7.8% |
| (I-5) drench | | | | |
| Karate Zeon | 0% | 69.4% | 96.7% | 100% |
| CS100 | | | | |

### 3. Larvae Treatment—Episyrphus

Beneficial species: Episyrphus balteatus larvae
Pest: Myzus persicae

Per experiment, 3 repetitions with in each case 2 pot cages with in each case 5 larvae are carried out.

For the experiment, Savoy cabbage plants are grown in pots having a diameter of 14 cm, placed in a breeding cage and infested thoroughly with Myzus persicae.

After the spray coating has dried on, a quartz sand layer of a thickness of about 1 cm is applied to the soil in the pot, and the pot cage is put over the plant. In each case 5 Episyrphus larvae are then counted out, and in each case 5 specimen are added to the plants in the pot cage.

For each plant, at the beginning the Myzus persicae number is estimated at the appropriate points in time and the dead, dying and alive larvae are counted separately. All larvae, i.e. all larvae present on the plant and the surface of the quartz sand base, are counted.

The experimental results, averaged over 3 repetitions, are listed in the table below:

| | Infestation by Myzus persicae (number per plant) | |
|---|---|---|
| Treatment | prior to application | 5 days after application |
| control (without active | 389 | 323 |
| compound) | | |
| compound (I-5) foliar | 375 | 0 |
| compound (I-5) drench | 394 | 23 |
| Karate Zeon CS100 | 403 | 0 |

| | Number of Episyrphus balteatus larvae on Savoy cabbage | | | |
|---|---|---|---|---|
| | (cage) (control) or kill [% Abbott] | | | |
| | 0 days after | 1 day after | 3 days after | 5 days after |
| Treatment | application | application | application | application |
| control | 57.7 | 55 | 26 | 5.7 |
| (without active | | | | |
| compound) | | | | |
| compound | 0% | 6.1% | 9% | 0% |
| (I-5) foliar | | | | |
| compound | 0% | 10.3% | 10.3% | 0% |
| (I-5) drench | | | | |
| Karate Zeon | 0% | 76.4% | 100% | 100% |
| CS100 | | | | |

### 4. Treatment—Anthocoris Adult

Beneficial species: Anthocoris nemoralis adults
Pest: Metopolophium dirhodum

Per experiment, 3 repetitions with in each case 2 pot cages with in each case 5 adults are carried out.

For the experiment, maize plants are grown in pots having a diameter of 14 cm, placed in a breeding cage and infested thoroughly with Metopolophium dirhodum. Per experiment, 6 pots having a well-established aphid population are selected and the aphids are rated by estimation of their number. The plants are treated with the active compound solution of the appropriate concentration.

After the spray coating has dried on, a quartz sand layer of a thickness of about 1 cm is applied to the soil in the pot, and the pot cage is put over the plant.

In each case 5 Anthocoris adults are then counted out, and in each case 5 specimen are added to the plants in the pot cage.

For each plant, at the beginning the Metopolophium dirhodum number is estimated at the appropriate points in time and the dead, dying and alive adults are counted separately. All adults, i.e. all adults present on the plant and the surface of the quartz sand base, are counted.

The experimental results, averaged over 3 repetitions, are listed in the table below:

| | Infestation by Metopolophium | |
|---|---|---|
| | dirhodum (number per plant) | |
| Treatment | prior to application | 5 days after application |
| control (without active | 83 | 53 |
| compound) | | |
| compound (I-5) foliar | 78 | 0 |
| compound (I-5) drench | 85 | 2.5 |
| Karate Zeon CS100 | 70 | 0 |

| | Number of adult Anthocoris nemoralis on 6 maize | | | |
|---|---|---|---|---|
| | plants (control) or kill [% Abbott] | | | |
| | 0 days after | 1 day after | 3 days after | 5 days after |
| Treatment | application | application | application | application |
| control | 60 | 60 | 60 | 60 |
| (without active | | | | |
| compound) | | | | |
| compound | 0% | 0% | 3.3% | 6.7% |
| (I-5) foliar | | | | |
| compound | 0% | 0% | 1.7% | 3.3% |
| (I-5) drench | | | | |
| Karate Zeon | 0% | 68.3% | 98.3% | 100% |
| CS100 | | | | |

5. Residual Test with Adult Orius laevigatus

Foliar treatment is carried out using compound (I-5) in a concentration of 100 g of active compound per hectare.

Drench treatment is carried out using compound (I-5) in a concentration of 15 mg of active compound per plant.

Foliar treatment with Karate Zeon CS100 as toxic control was carried out in a concentration of 12.5 g of active compound per hectare. The active compound in its respective formulation is brought to the required concentration by dilution with water.

Bell-pepper plants cultivated in a greenhouse are treated with the respective active compound solutions. 1, 8, 16 and 23 days after the application, leaves are plucked from the test plants (5 samples per plot). The individual leaves are then mounted in test cages. 10 adult Orius laevigatus are added to each cage. The test cages are placed under controlled conditions in a climatized chamber. The kill of the insects is determined after 24, 48 and 72 hours of exposure.

The test results are listed in the table below:

| | Activity against adult Orius leavigatus on bell-pepper | | | |
|---|---|---|---|---|
| | [% kill calculated according to Schneider-Orelli] | | | |
| | 1 day after | 8 days after | 16 days after | 23 days after |
| Treatment | application | application | application | application |
| compound | 100% | 98.1% | 100% | 100% |
| (I-5) foliar | | | | |
| compound | 36.3% | 86.7% | 72.3% | 92.1% |
| (I-5) drench | | | | |
| Karate Zeon | 100% | 100% | 100% | 100% |
| CS100 | | | | |

6. Residual Test with Nymphs of Macrolophus caliginosus

Foliar treatment is carried out using compound (I-5) in a concentration of 100 g of active compound per hectare.

Drench treatment is carried out using compound (I-5) in a concentration of 15 mg of active compound per plant.

Foliar treatment with Karate Zeon CS100 as toxic control was carried out in a concentration of 12.5 g of active compound per hectare. The active compound in its respective formulation is brought to the required concentration by dilution with water.

Tomato plants cultivated in a greenhouse are treated with the respective active compound solutions. 1, 8, 16 and 23 days after the application, leaves are plucked from the test plants (5 samples per plot). The individual leaves are then mounted in test cages. 10 Macrolophus caliginosus nymphs are added to each cage. The test cages are placed under controlled conditions in a climatized chamber. The kill of the insects/larvae is determined after 24, 48 and 72 hours of exposure.

The test results are listed in the table below:

| | Activity against nymphs of Macrolophus caliginosus | | | |
|---|---|---|---|---|
| | on tomato [% kill according to Schneider-Orelli] | | | |
| | 1 day after | 8 days after | 16 days after | 23 days after |
| Treatment | application | application | application | application |
| compound (I-5) | 52.2% | 72.2% | 21.7% | 41.8% |
| foliar | | | | |
| compound (I-5) | 0% | 65.4% | 35.7% | 23.6% |
| drench | | | | |
| Karate Zeon | 61.2% | 68.8% | 65.1% | 51.2% |
| CS100 | | | | |

7. Residual Test with Adult Nesidiocoris tennis

Foliar treatment is carried out using compound (I-5) in a concentration of 150 g of active compound per hectare.

Drench treatment is carried out using compound (I-5) in a concentration of 10 mg of active compound per plant.

Foliar treatment with Karate Zeon CS100 as toxic control was carried out in a concentration of 12.5 g of active compound per hectare. The active compound in its respective formulation is brought to the required concentration by dilution with water.

Tomato plants cultivated in a greenhouse are treated with the respective active compound solutions. 1, 8, 15 and 22 days after the application, leaves are plucked from the test plants (5 samples per plot). The individual leaves are then mounted in test cages. 10 adult Nesidiocoris tenuis are added to each cage. The test cages are placed under controlled conditions in a climatized chamber. The kill of the insects is determined after 24, 48 and 72 hours of exposure.

The test results are listed in the table below:

| | Activity against adult Nesidiocoris tenuis on tomato | | | |
|---|---|---|---|---|
| | [% kill according to Schneider-Orelli] | | | |
| | 1 day after | 8 days after | 15 days after | 22 days after |
| Treatment | application | application | application | application |
| compound (I-5) | 91.1% | 81.3% | 32.1% | 45.8% |
| foliar | | | | |
| compound (I-5) | 4.9% | 47.3% | 24.4% | 66% |
| drench | | | | |
| Karate Zeon | 74.2% | 46% | 40.4% | 40.3% |
| CS100 | | | | |

1. A combination of an enaminocarbonyl compound and beneficial species, said combination comprising
at least one enaminocarbonyl compound of formula (I) 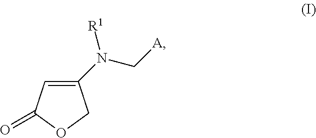
in which
A represents the 6-fluoropyrid-3-yl, 6-chloropyrid-3-yl, 6-bromopyrid-3-yl, 5-fluoro-6-chloropyrid-3-yl, 2-chloro-1,3-thiazol-5-yl or 5,6-dichloropyrid-3-yl radical and
R¹ represents methyl, cyclopropyl, methoxy, 2-fluoroethyl or 2,2-difluoroethyl and
at least one beneficial species from the families of the Alloxystidae, Angstidae, Aphelinidae, Aphidiidae, Asilidae, Braconidae, Cantharidae, Carabidae, Cecidomyiidae, Chameiidae, Chrysopidae, Cleridae, Coccinellidae, Coniopterygidae, Encyrtidae, Eulophidae, Eumenidae, Euzetidae, Forficulidae, Hemerobiidae, Ichneumonidae, Megaspilidae, Mymaridae, Phytoseiidae, Sphecidae, Staphylenidae, Stigmaeidae, Syrphidae, Tachnidae, Trichogrammatidae, Trombidiidae, Vespidae, predatory mites and nematodes and/or parasitiformes or at least one bacteria strain or at least one virus strain.

2. A combination according to claim 1, wherein the at least one beneficial species belongs to one of the families Eumenidae, Sphecidae, Vespida, Aphelinidae, Trichogrammatidae, Encyrtidae, Mymaridae, Ichneumoidae, Eulophidae, Alloxystidae, Megaspilidae, Braconidae, Aphidiidae, Coccinellidae, Staphylemidae, Chrysopidae, Hemerobiidae, Tachimidae, Syrphidae, Cecidomyiidae or Phytoseida.

3. A combination according to claim 1, wherein the enaminocarbonyl compound is selected from the group consisting of compounds of formulae (I-1), (I-2), (I-3), (I-4), (I-5), (I-6), (I-7), (I-8), (I-9) and (I-10)

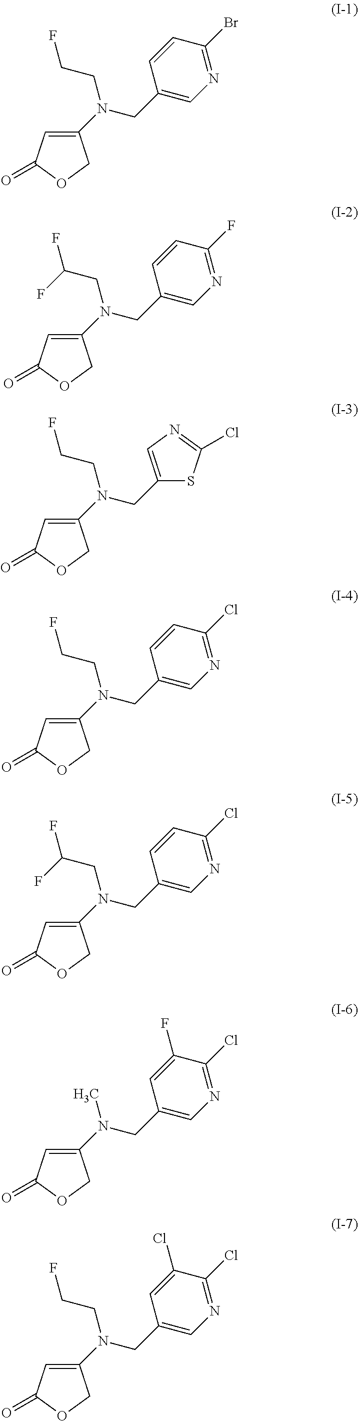

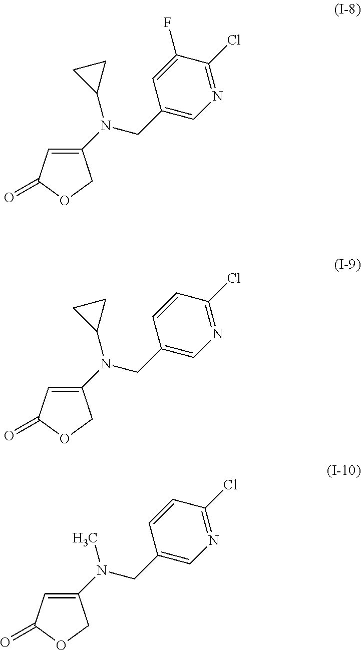

4. A combination as defined in claim 1 which is suitable for controlling animal plant pests.

5. A combination according to claim 4, where the enaminocarbonyl compound of formula (I) and the at least one beneficial species are applied at different times and/or locations.

6. Method for controlling animal pests, comprising allowing a combination as defined in claim 1 to act on the animal plant pests and/or a habitat thereof.

7. Process for preparing an insecticidal and/or acaricidal composition, comprising mixing a combination as defined in claim 1 with an extender and/or surfactant.

8. Method for reducing the number of active compound applications per planting season, comprising using a combination as defined in claim 1.

9. Method for reducing the total residues of insecticides and/or acaricides on the harvested material and in the environment, comprising using a combination as defined in claim 1.

10. Composition comprising a combination according to claim 1 for controlling animal plant pests.
